(19) United States
(12) Patent Application Publication
(10) Pub. No.: US 2022/0198792 A1
(43) Pub. Date: Jun. 23, 2022

(54) INSPECTION DEVICE

(71) Applicant: DENSO CORPORATION, Kariya-city (JP)

(72) Inventors: Kazue ASANO, Kariya-city (JP); Motohiro SHIRAI, Kariya-city (JP)

(21) Appl. No.: 17/690,455

(22) Filed: Mar. 9, 2022

Related U.S. Application Data
(63) Continuation of application No. PCT/JP2020/034904, filed on Sep. 15, 2020.

(30) Foreign Application Priority Data
Oct. 16, 2019 (JP) 2019-189542

(51) Int. Cl. G06V 10/98; G06V 10/12; G06V 10/94

(52) U.S. Cl. CPC G06V 10/993; G06V 10/95; G06V 10/12

(57) ABSTRACT

An inspection device includes an imaging device, a determinator and a communication device. The imaging device is detachably attached to an operator to image an imaging range. The determinator is configured to determine a quality of the inspection object. The communication device is separated from the imaging device to wirelessly transmit image data of the imaging range captured by the imaging device to the determinator. The determinator is configured to collate the image data of the imaging range wirelessly transmitted from the communication device with collation image data registered in advance, and to determine the quality of the inspection object in response to a collation result.

### CROSS REFERENCE TO RELATED APPLICATION

The present application is a continuation application of International Patent Application No. PCT/JP2020/034904 filed on Sep. 15, 2020, which designated the U.S. and claims the benefit of priority from Japanese Patent Application No. 2019-189542 filed on Oct. 16, 2019. The entire disclosures of all of the above applications are incorporated herein by reference.

### TECHNICAL FIELD

The present disclosure relates to an inspection device used for inspecting an inspection object.

### BACKGROUND

An inspection device that can be attached to an operator may include a code reader, a camera, and a tablet. The code reader reads a code indicating the type of work to be inspected, and the camera takes an image of the work. A microcomputer of the tablet sends wirelessly an imaging command to the camera in response to that the code reader reads the work code as a trigger. The camera has a built-in wireless unit for receiving an imaging command wirelessly transmitted from the tablet. The camera captures the work based on the imaging command, and then transmits the captured image of the work to the tablet. The microcomputer of the tablet selects a reference image of the work corresponding to the code read by the code reader from among reference images of a plurality of types of works stored in advance in a memory, and the reference image and the captured image of the selected work collate with each other, so as to determine whether or not the selected work is a non-defective product (i.e., good product). Since the inspection device requires a camera having a built-in wireless unit, the degree of freedom in selecting the camera becomes low.

### SUMMARY

An inspection device according to an aspect of the present disclosure can be used for inspecting an inspection object, and includes an imaging device, a determinator and a communication device. The imaging device is detachably attached to an operator to image an imaging range. The determinator is configured to determine a quality of the inspection object. The communication device is separated from the imaging device to wirelessly transmit image data of the imaging range captured by the imaging device to the determinator. The determinator is configured to collate the image data of the imaging range wirelessly transmitted from the communication device with collation image data registered in advance, and to determine the quality of the inspection object in response to a collation result.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically showing a part of a manufacturing process of a first embodiment of the present disclosure;

FIG. 2 is a block diagram showing a configuration of an inspection device according to the first embodiment;

FIG. 3 is a block diagram showing another configuration of an inspection device according to the first embodiment;

FIG. 4 is a diagram schematically showing a part of a manufacturing process of a second embodiment of the present disclosure; and

FIG. 5 is a block diagram showing a configuration of an inspection device according to the second embodiment.

### DESCRIPTION OF EMBODIMENT

If an inspection device uses a camera having a built-in wireless unit, the degree of freedom in selecting the camera may be remarkably low in the inspection device. This is one of the factors that reduce the degree of freedom in designing the entire inspection device.

An object of the present disclosure is to provide an inspection device capable of improving the degree of freedom in selecting an imaging device.

An inspection device according to an exemplar of the present disclosure can be used for inspecting an inspection object. The inspection device includes an imaging device, a determinator and a communication device. The imaging device is detachably attached to an operator to image an imaging range. The determinator is configured to determine a quality of the inspection object. The communication device is separated from the imaging device to wirelessly transmit image data of the imaging range captured by the imaging device to the determinator. The determinator is configured to collate the image data of the imaging range wirelessly transmitted from the communication device with collation image data registered in advance, and to determine the quality of the inspection object in response to a collation result.

According to this configuration, since the imaging device and the communication device are separated from each other, any imaging device that does not have a wireless communication function can be used as the imaging device. Therefore, the degree of freedom in selecting the imaging device can be improved.

For example, the communication device may include an image processing unit configured to perform a predetermined image process with respect to the image data of the imaging range, and a wireless transmission unit configured to wirelessly transmit the image data subjected to the predetermined image process in the image processing unit, to the determinator.

The inspection device may be provided with a battery built in the communication device or externally attached to the communication device. In this case, the battery may be configured to supply power to the communication device, and to supply the power to the imaging device through the communication device.

The inspection device may be provided with a plurality of the imaging devices. In this case, the determinator may be configured to determine the quality of the workpiece by collating the image data transmitted from the plurality of imaging devices in order, with the collation image data.

Hereinafter, an inspection device of the present disclosure will be described with reference to the drawings. In order to facilitate the understanding, the same reference numerals are attached to the same constituent elements in each drawing where possible, and redundant explanations are omitted.

### First Embodiment

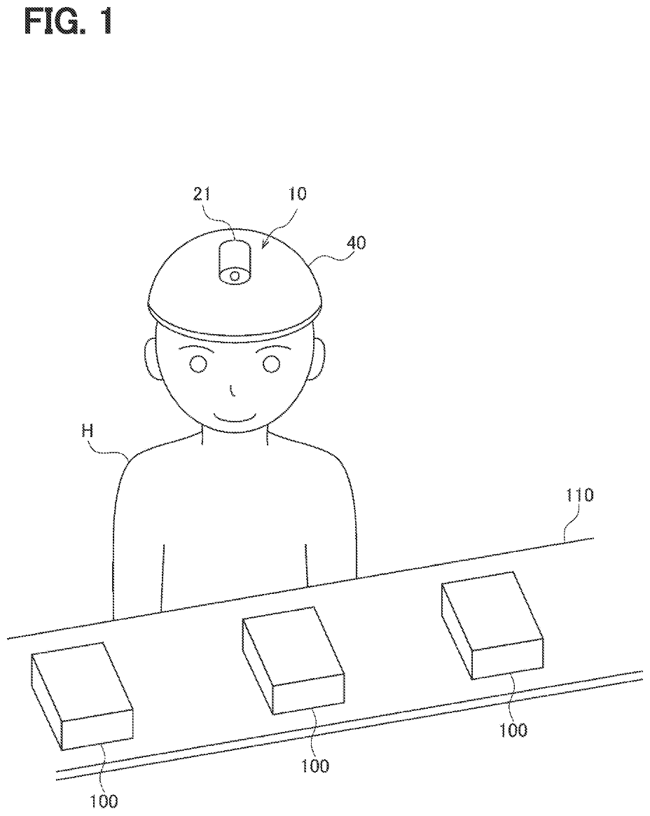

First, an inspection device 10 according to the first embodiment shown in FIG. 1 will be described. The inspection device 10 according to the first embodiment is used in a manufacturing process of a product such as a heat exchanger, an electrical device or the like. Specifically, the inspection device 1 is used at an intermediate manufacturing stage before a finished product, to inspect whether or not an inspection object such as a workpiece 100 is a good product (i.e., non-defective product). Specifically, the workpiece 100 is flowing on a production line while being placed on a conveyor 110. In the vicinity of the conveyor 110, a plurality of operators (e.g., workers) H are lined up along a flow direction of the workpiece 100. When the workpiece 100 is positioned in front of the operator H, the operator H performs an assembling work for assembling a predetermined part or predetermined plural parts at the position of the workpiece 100. At that time, the inspection device 10 is configured to inspect whether or not the workpiece 100, to which the predetermined part(s) is assembled, is a non-defective product (good product). The inspection device 10 is a wearable inspection device that can be worn by the operator H, for example. Each operator H sequentially performs the assembly work of predetermined parts so that a finished product is manufactured. In this embodiment, the workpiece 100 corresponds to the inspection object (i.e., an object to be inspected).

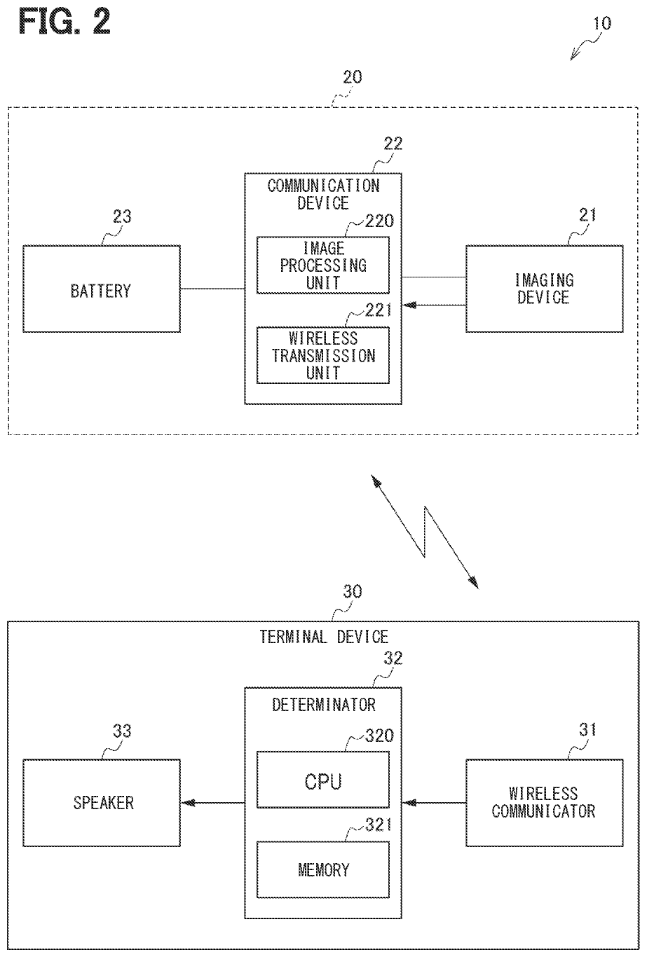

As shown in FIG. 2, the inspection device 10 includes an image pickup set 20 and a terminal device 30.

The image pickup set 20 is a set of the imaging device 21, a communication device 22, and a battery 23, and is attached to the operator H. In FIG. 1, only the imaging device 21 is shown, but the communication device 22 and the battery 23 are not shown.

As shown in FIG. 1, the imaging device 21 can be worn by the operator H. The imaging device 21 is fixedly attached to a helmet 40 worn on the head of the operator H. The imaging range of the imaging device 21 is set to a predetermined range in the direction in which the face of the operator H is facing, that is, in front of the operator H. When the operator H turns his/her face toward the workpiece 100 in order to assemble a predetermined part to the workpiece 100, the entire workpiece 100 is positioned within the imaging range of the imaging device 21. The imaging device 21 constantly images the imaging range regardless of whether or not the workpiece 100 is present in the imaging range, and transmits the image data of the captured imaging range to the wireless communication device 22 shown in FIG. 2. In the present embodiment, the imaging device 21 is an example of an image pickup unit.

The communication device 22 is separated from the imaging device 21 and is connected to the imaging device 21 by a wire or wireless communication. In this embodiment, the communication device 22 can be used as a communicator to transmit the image data transmitted from the imaging device 21 to the terminal device 30. The communication device 22 sequentially transmits the image data transmitted from the imaging device 21 to the terminal device 30 by wireless communication or the like. Wi-Fi can be used as the wireless communication between the communication device 22 and the terminal device 30. In the present embodiment, the communication device 22 functions as a master unit (base unit) for Wi-Fi communication, and the terminal device 30 functions as a slave unit (cordless extension unit) for Wi-Fi communication. The communication device 22 includes a processor such as an image processing unit 220 and a wireless transmission unit 221.

The image processing unit 220 is configured to perform a predetermined image process with respect to the image data of the imaging range transmitted from the imaging device 21. Specifically, the imaging device 21 compresses the image data of the imaging range in a predetermined compression format and transmits the compressed image data to the communication device 22. The image processing unit 220 restores the compressed image data by performing a decoding process with respect to the compressed image data. Further, the image processing unit 220 converts the image data into wireless-transmission image data in a format that can be wirelessly transmitted to the terminal device 30 by performing an encoding process with respect to the restored image data.

The image processing unit 220 may perform a compression process for reducing the amount of data per image data by performing a trimming process, an enlargement/reduction process, or the like on the image data during the encoding process. By performing such compression process on the image data, the amount of data wirelessly transmitted from the communication device 22 to the terminal device 30 can be reduced, so that the data transfer speed between the communication device 22 and the terminal device 30 can be improved.

The wireless transmission unit 221 wirelessly transmits the image data subjected to the predetermined image process in the image processing unit 220, to the terminal device 30.

The battery 23 is externally connected to the communication device 22. The communication device 22 is driven based on the electric power supplied from the battery 23. The communication device 22 supplies the electric power supplied from the battery 23 to the imaging device 21. The imaging device 21 is driven by the electric power supplied from the battery 23 via the communication device 22.

The terminal device 30 is a portable tablet terminal, a stationary personal computer, or the like. The terminal device 30 determines the quality of the workpiece 100 based on the image data wirelessly transmitted from the imaging device 21 via the communication device 22, and notifies the operator H of the determination result. The terminal device 30 includes a wireless communicator 31, a determinator 32, and a speaker 33.

The wireless communicator 31 receives the image data sequentially transmitted from the communication device 22, and transmits the received image data to the determinator 32.

The determinator 32 is mainly configured by a microcomputer having a CPU 320, a memory 321, and the like. The determinator 32 is configured to perform a control program stored in the memory 321. Specifically, the determinator 32 is configured to perform an image process for extracting an image data of the workpiece 100 from the image data in the imaging range by executing a program stored in advance in the memory 321, and to perform a determination process for determining the quality of the workpiece 100 based on the extracted image data of the workpiece 100. The determinator 32 collates the image data of the workpiece 100 with collation image data in the determination process. The collation image data is image data obtained by preliminarily photographing a non-defective workpiece 100, and is stored in the memory 321. The determinator 32 collates the image data of the workpiece 100 with the collation image data, and determines that the workpiece 100 is a non-defective product if the collation is established. On the other hand, when the collation between the image data of the workpiece 100 and the collation image data is not established, the determinator 32 determines that the workpiece 100 is a defective product. That is, the determinator 32 determines the quality of the workpiece 100 in response to a collation result between the image data of the workpiece 100 and the collation image data.

The determinator 32 notifies the speaker 33 of the quality determination result of the workpiece 100 obtained through the determination process. Specifically, when the determinator 32 determines that the workpiece 100 is a non-defective product (good product), the determinator 32 outputs a first sound indicating the non-defective product from the speaker 33. When the determinator 32 determines that the workpiece 100 is a defective product (bad product), the determinator 32 outputs a second sound indicating the defective product from the speaker 33. The first sound and the second sound are different sounds.

According to the inspection device 10 of this embodiment described above, operations and effects described in the following (i) to (iii) can be obtained.

(i) Since the imaging device 21 and the communication device 22 are separate members separated from each other, any imaging device having no wireless communication function can be used as the imaging device 21. Therefore, the degree of freedom in selecting the imaging device 21 can be improved.

(ii) The communication device 22 includes the image processing unit 220 and the wireless transmission unit 221. The image processing unit 220 is configured to perform the image processing on the image data of the imaging range imaged by the imaging device 21, and the wireless transmission unit 221 is configured to wirelessly transmit the image data processed by the image processing unit 220 to the determinator 32 of the terminal device 30. According to this configuration, the image data compressed by the image processing unit 220 can be wirelessly transmitted to the terminal device 30, so that the amount of data transmitted wirelessly can be reduced. As a result, the transfer speed of wireless communication between the communication device 22 and the terminal device 30 can be improved.

(iii) The inspection device 10 further includes the battery 23 externally attached to the communication device 22, so that power is supplied to the communication device 22 from the battery 23. The imaging device 21 is driven by the electric power supplied from the battery 23 via the communication device 22. In the present embodiment, because the battery 23 is used in common for both the imaging device 21 and the communication device 22, the buttery number can be reduced and the entire structure can be made simple as compared with a configuration in which batteries are respectively and separately provided for the imaging device 21 and the communication device 22.

### Modifications

Next, a modified example of the inspection device 10 of the first embodiment will be described.

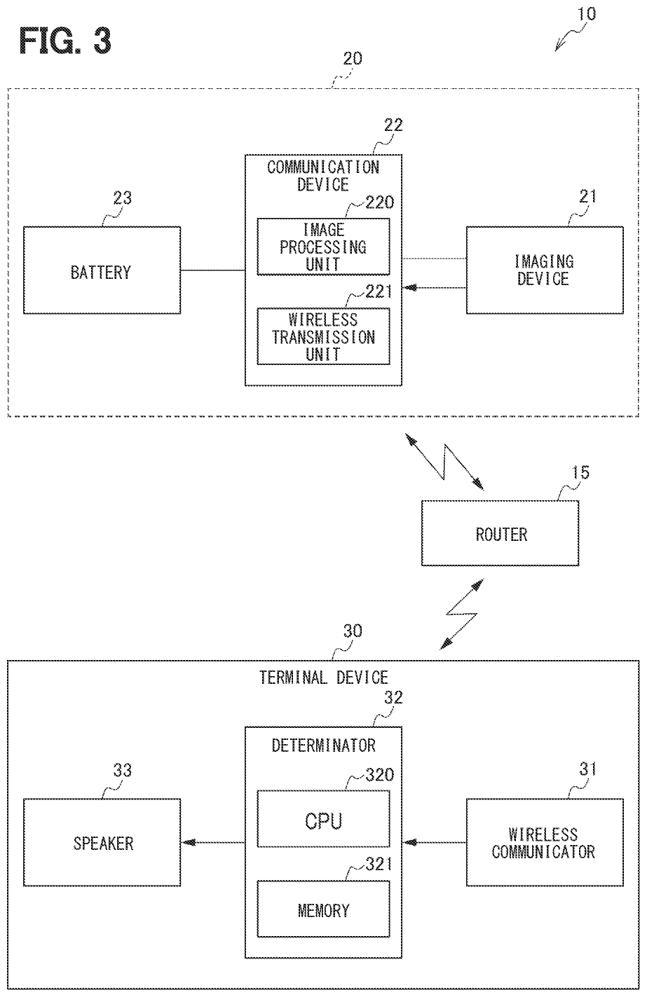

As shown in FIG. 3, the inspection device 10 further includes a router 15 that relays wireless communication between the communication device 22 and the terminal device 30. The router 15 functions as a master unit (i.e., base unit) in Wi-Fi communication. The communication device 22 and the terminal device function as slave units (extension units) in Wi-Fi communication.

According to the configuration of the inspection device 10 shown in FIG. 3, the load of communication process of the communication device 22 can be reduced, and thereby it is possible to improve the communication speed as compared with a case where the communication device 22 functions as a master unit for Wi-Fi communication.

### Second Embodiment

Next, an inspection device 10 of the second embodiment will be described. Hereinafter, differences from the inspection device 10 of the first embodiment will be mainly described.

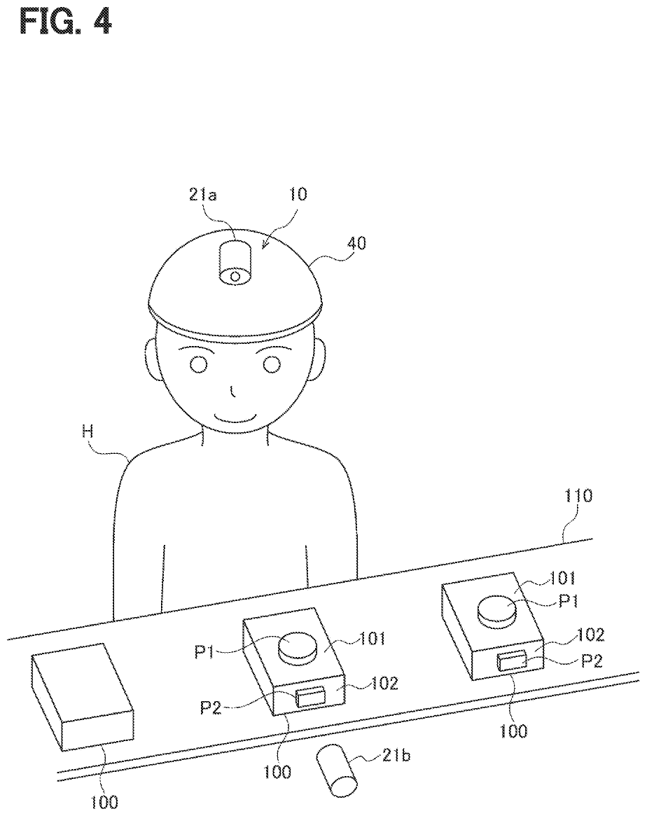

As shown in FIG. 4, the operator H of the present embodiment assembles a component part P1 on an upper surface 101 of the workpiece 100, and then assembles a component part P2 on a back surface 102 of the workpiece 100. When the operator H performs such an operation, an imaging device 21a attached to the helmet 40 of the operator H can image the upper surface 101 of the workpiece 100. Therefore, it is possible to determine whether or not the component part P1 is properly assembled on the upper surface 101 of the workpiece 100 by using the image data captured by the imaging device 21a. However, in this case, the imaging device 21a cannot image the back surface 102 of the workpiece 100, and it may be difficult to determine whether or not the component part P2 is properly assembled to the back surface 102 of the workpiece 100. In the present embodiment, the inspection device 10 further includes an imaging device 21b capable of imaging the back surface 102 of the workpiece 100, in addition to the imaging device 21a assembled to the top surface 101 of the workpiece 100.

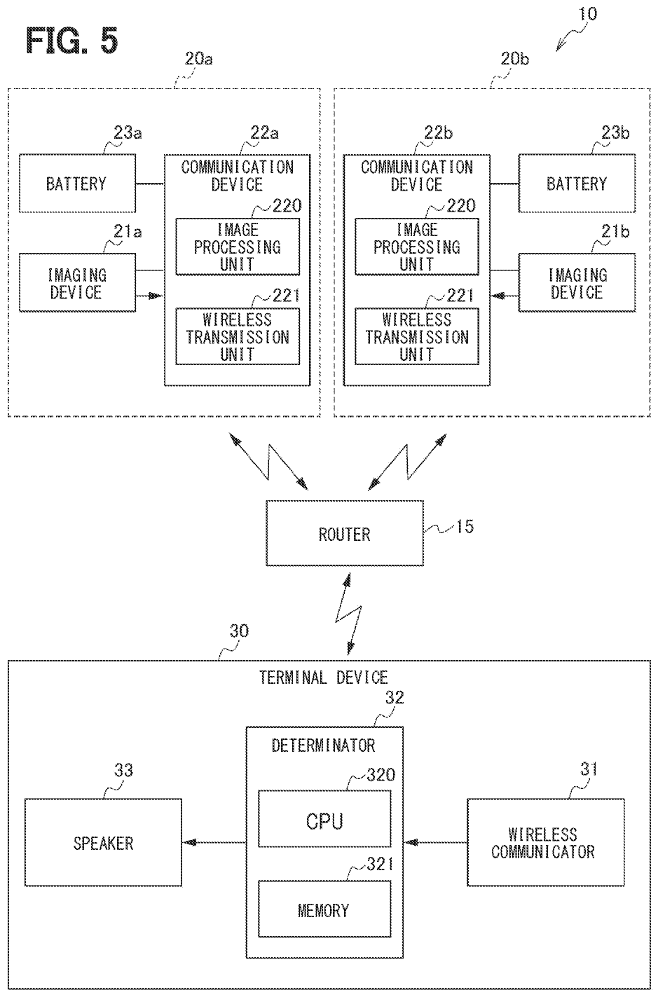

Specifically, as shown in FIG. 5, the inspection device 10 includes a first image pickup set 20a and a second image pickup set 20b. The first image pickup set includes an imaging device 21a, a communication device 22a and a battery 23a. Similarly, the second image pickup set 20b includes an imaging device 21b, a communication device 22b, and a battery 23b.

As shown in FIG. 4, the first image pickup set 20a is worn by an operator. In FIG. 4, the imaging device 21a of the first image pickup set 20a is indicated while the communication device 22a and the battery 23a of the first image pickup set 20a are omitted. The imaging range of the imaging device 21a is set to a predetermined range in the direction in which the face of the operator H is facing, that is, in front of the operator H, similarly to the imaging device 21 of the first embodiment. As a result, when the workpiece 100 is positioned in front of the operator H, the upper surface 101 of the workpiece 100 is placed in the imaging range of the imaging device 21a.

The second image pickup set 20b is fixed to a predetermined portion of the conveyor 110, arranged in a manufacturing process. As shown in FIG. 4, the imaging device 21b of the image pickup set 20b is fixedly disposed so that the back surface 102 of the workpiece 100 is within the imaging range when the workpiece 100 is positioned in front of the operator H.

In the memory 321 of the determinator 32 of the terminal device 30 shown in FIG. 5, first collation image data obtained by preliminarily imaging the upper surface 101 of the non-defective workpiece 100 and second collation image data obtained by preliminarily imaging the back surface 102 of the non-defective workpiece 100 are stored as the collation image data.

First, the determinator 32 of the terminal device 30 acquires the image data of the imaging device 21a via the communication device 22a, and collates the acquired image data with the first collation image data. When the image data of the imaging device 21a is collated with the first collation image data, that is, when the component part P1 is appropriately assembled on the upper surface 101 of the workpiece 100, the determinator 32 switches the acquisition destination of the image data from the first communication device 22a to the second communication device 22b. As a result, the determinator 32 acquires the image data of the second imaging device 21b via the second communication device 22b, and collates the acquired image data with the second collation image data. When the image data of the second imaging device 21b is collated with the second collation image data, that is, when the component part P2 is appropriately assembled onto the back surface 102 of the workpiece 100, the determinator 32 determines that the workpiece 100 is a non-defective product.

According to the inspection device 10 of the present embodiment described above, operations and effects described in the following (iv) can be further obtained in addition to the above (i) to (iii) of the first embodiment.

(iv) The determinator 32 determines the quality of the workpiece 100 by collating the image data transmitted from the plurality of imaging devices 21a and 21b in order, with respective collation image data. According to this configuration, it is possible to further inspect whether or not the component part P2 is properly assembled to the back surface 102 of the workpiece 100, which cannot be imaged by the imaging device 21a. Therefore, the inspection area of the workpiece 100 can be expanded as compared with the inspection device 10 of the first embodiment.

### Other Embodiments

The embodiments described above can be also implemented in the following forms.

The arrangement positions of the image pickup sets 20a and 20b of the second embodiment can be appropriately changed in accordance with the positions of the component parts P1 and P2 to be assembled to the workpiece 100. For example, the image pickup set 20b is not limited to the predetermined position of the conveyor 110 in the manufacturing process, but may be attached to the body of the operator H such as the arm or the leg of the operator H.

The inspection device 10 of the second embodiment is not limited to the two image pickup sets 20a and 20b, but may have three or more image pickup sets. The battery 23 may be built in the communication device 22.

The terminal device 30 may have a display unit or the like that displays the quality of a determination result of the workpiece 100 as an image.

The wireless communication format between the communication device 22 and the terminal device 30 is not limited to Wi-Fi, and any communication format such as Bluetooth (registered trademark) can be used.

The present disclosure is not limited to the specific examples described above. The specific examples described above which have been appropriately modified in design by those skilled in the art are also encompassed in the scope of the present disclosure so far as the modified specific examples have the features of the present disclosure. Each element included in each of the specific examples described above, and the placement, condition, shape, and the like of the element are not limited to those illustrated, and can be modified as appropriate. Each element included in each of the specific examples described above can be appropriately combined together as long as there is no technical contradiction.

What is claimed is:

1. An inspection device used for inspecting an inspection object to be inspected, the inspection device comprising:
an imaging device detachably attached to an operator to image an imaging range;
a determinator configured to determine whether or not a quality of the inspection object is defective; and
a communication device separated from the imaging device to wirelessly transmit image data of the imaging range captured by the imaging device to the determinator, wherein
the determinator is configured to collate the image data of the imaging range wirelessly transmitted from the communication device with collation image data registered in advance, and to determine the quality of the inspection object in response to a collation result.

2. The inspection device according to claim 1, wherein
the communication device includes
an image processing unit configured to perform a predetermined image process with respect to the image data of the imaging range, and
a wireless transmission unit configured to wirelessly transmit the image data subjected to the predetermined image process in the image processing unit, to the determinator.

3. The inspection device according to claim 1, further comprising
a battery built in the communication device or externally attached to the communication device, wherein
the battery is configured to supply power to the communication device, and to supply the power to the imaging device through the communication device.

4. The inspection device according to claim 1, wherein
a plurality of the imaging devices are provided, and
the determinator is configured to determine the quality of the workpiece by collating the image data transmitted from the plurality of imaging devices in order, with the collation image data.

5. An inspection device used for inspecting an inspection object to be inspected, the inspection device comprising:
an imaging device configured to image an imaging range;
a determinator configured to determine whether or not a quality of the inspection object is defective;
a communicator separated from the imaging device to wirelessly transmit image data of the imaging range captured by the imaging device to the determinator; and
a battery provided at the communicator to supply power to the communicator, and to supply the power to the imaging device through the communicator, wherein
the determinator is configured to collate the image data of the imaging range transmitted from the communicator with collation image data registered in advance, and to determine the quality of the inspection object in response to a collation result.
